(19) United States
(12) Patent Application Publication
(10) Pub. No.: US 2008/0302488 A1
(43) Pub. Date: Dec. 11, 2008

(54) LABEL PEELING APPARATUS

(75) Inventor: Guo-Xin Liang, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/964,559

(22) Filed: Dec. 26, 2007

(30) Foreign Application Priority Data
Jun. 8, 2007 (CN) 200710074782.3

(51) Int. Cl. B32B 38/10

(52) U.S. Cl. 156/584

(57) ABSTRACT

A label peeling apparatus (100) includes a case (10), a power device (20), a tape driving mechanism (30) and a peeling member (60). The power device is mounted on the case. The tape driving mechanism is mounted on the case and driven by the power device. The tape driving mechanism drives a tape (901/903) attached by labels (902/904) to move. The peeling member is mounted on the case configured for peeling the labels from the tape.

### BACKGROUND OF THE INVENTION

1. Field of the Invention

The present invention relates to label peeling apparatuses, particularly to a label peeling apparatus used to peel labels attached on tapes.

2. Description of Related Art

Nowadays, labels such as trademarks, barcodes and certificates are required to be attached to workpieces for various reasons such as identification, pricing and etc. Generally, a tape is used to carry the labels. The tape includes a smooth surface and a rough surface, and the labels are detachably glued on the smooth surface. In use, the labels are peeled from the tape, and then attached to workpieces via the glue.

Nowadays, in most operation, labels are manually peeled from the tape and attached to the workpieces. The manual peeling operation is time consuming, and the labels may easily be torn during peeling operation.

Therefore, a new label peeling apparatus is desired in order to overcome the above-described shortcomings.

### SUMMARY

A label peeling apparatus includes a case, a power device, a tape driving mechanism and a peeling member. The power device is mounted on the case. The tape driving mechanism is mounted on the case and driven by the power device. The tape driving mechanism drives a tape with labels to move. The peeling member is mounted on the case configured for peeling the labels from the tape.

Other advantages and novel features will become more apparent from the following detailed description when taken in conjunction with the accompanying drawings.

### BRIEF DESCRIPTION OF THE DRAWINGS

Many aspects of the present label peeling apparatus can be better understood with reference to the following drawings. The components in the various drawings are not necessarily drawn to scale, the emphasis instead being placed upon clearly illustrating the principles of the present label peeling apparatus. Moreover, in the drawings, like reference numerals designate corresponding parts throughout the figures.

FIG. 1 is an isometric view of a label peeling apparatus in accordance with a present embodiment.

FIG. 2 is a partly disassembled view in a first visual angle of the label peeling apparatus shown in FIG. 1.

FIG. 3 is a partly disassembled view in a second visual angle of the label peeling apparatus shown in FIG. 1.

FIG. 4 is a disassembled view in a first visual angle of a clutch of the label peeling apparatus shown in FIG. 1.

FIG. 5 is similar to FIG. 4, but shown in another visual angle.

FIG. 6 is an assembled, isometric schematic view of the clutch shown in FIG. 4.

FIG. 7 is a schematic view of a peeling member of the label peeling apparatus shown in FIG. 1.

FIG. 8 is a disassembled view of a pressing mechanism of the label peeling apparatus shown in FIG. 1.

FIG. 9 is a isometric view of the pressing mechanism shown in FIG. 8.

FIG. 10 is a schematic view of using the label peeling apparatus shown in FIG. 1 to peel labels attached on a coiled tape.

FIG. 11 is a schematic view of using the label peeling apparatus shown in FIG. 1 to peel labels attached on a strip-shaped tape.

### DETAILED DESCRIPTION OF THE INVENTION

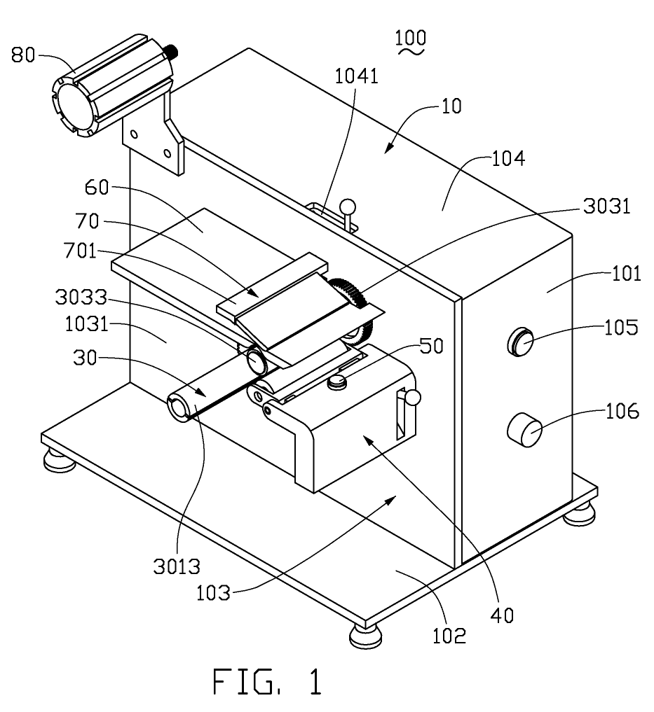

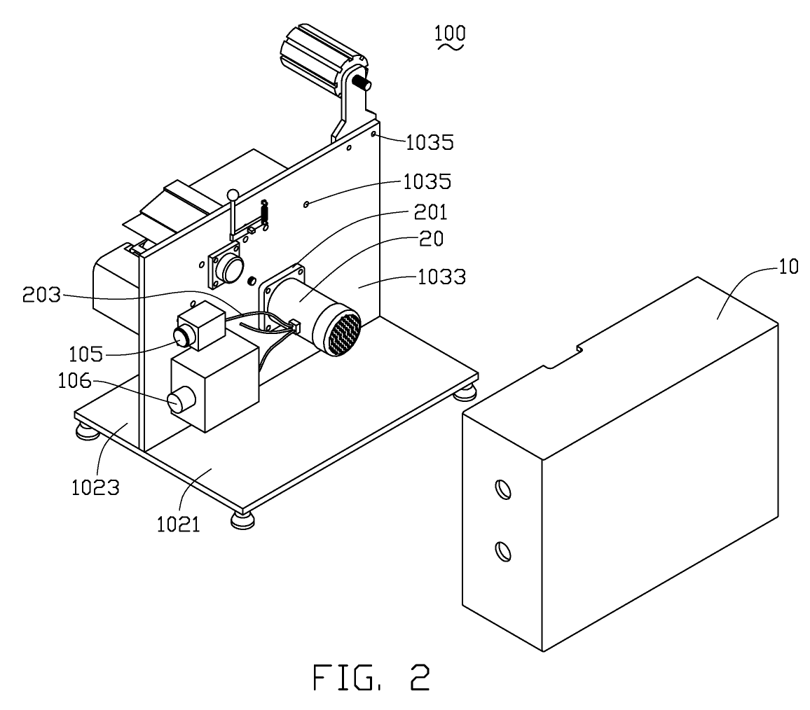

Referring to FIG. 1 and FIG. 2, a label peeling apparatus 100 in accordance with a present embodiment is provided. The label peeling apparatus 100 includes a case 10, a power device 20, a tape driving mechanism 30, a clutch 40, a photoelectric switch 50, a peeling member 60, a pressing mechanism 70 and a rotating mechanism 80. The photoelectric switch 50 is installed on the clutch 40. The power device 20, the tape driving mechanism 30, the clutch 40, the photoelectric switch 50, the peeling member 60, the pressing mechanism 70 and the rotating mechanism 80 are all mounted on the case 10.

The case 10 is a hollow cuboid and includes a control panel 101, a bottom board 102, a mounting board 103 and a top board 104. The control panel 101 and the mounting board 103 are both perpendicularly mounted on the bottom board 102, and perpendicularly connected with each other. The top board 104 is perpendicularly mounted on the control panel 101 and mounting board 103, and parallel to the bottom board 102.

The case 10 also includes a primary switch 105 and a speed adjusting switch 106. The primary switch 105 and the speed adjusting switch 106 are both mounted on the control panel 101. The bottom board 102 is divided into an inner bottom 1021 and an outer bottom 1023 by the mounting board 103. The mounting board 103 includes an outer mounting surface 1031 adjacent to the outer bottom 1023 and an inner mounting surface 1033 adjacent to the inner bottom 1021. The mounting board 103 defines a plurality of mounting holes 1035 therein. The top board 104 defines a through operating groove 1041 therein.

The power device 20 is a motor including a pedestal 201 formed at one end thereof and a plurality of wires 203. The power device 20 is mounted on the inner mounting surface 1033 via the pedestal 201. The power device 20 is electronically connected to the primary switch 105, the speed adjusting switch 106 and the photoelectric switch 50 via the wires 203. The power device 20 is mechanically connected to the tape driving mechanism 30 for supplying power to the tape driving mechanism 30.

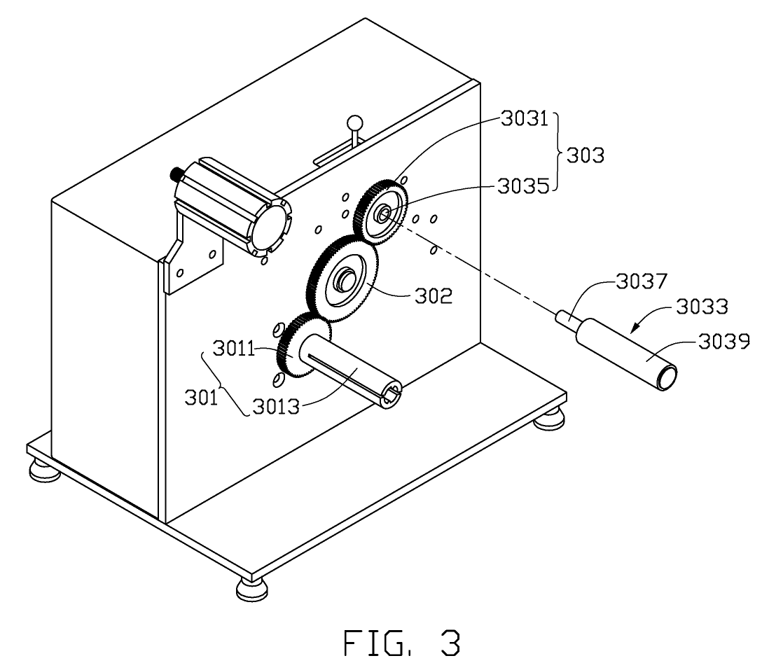

Also referring to FIG. 3, the tape driving mechanism 30 includes a first rotating member 301, a transmission member 302 meshing with the first rotating member 301 and a second rotating member 303 meshing with the transmission member 302. The first rotating member 301 is rotatably mounted on the mounting board 103. The first rotating member 301 includes a first gear 3011 and a tape recycling member 3013. A shaft (not shown) is inserted into a mounting hole 1035 and mechanically connected to the power device 20. The first gear 3011 and the tape recycling member 3013 are coaxially mounted on the shaft, thus the power device 20 can drive the first gear 3011 to rotate. The transmission member 302 is a gear meshing with the first gear 3011. A shaft (not shown) is inserted into a mounting hole 1035, thus the transmission member 302 is rotatably mounted on the mounting board 103. The second rotating member 303 includes a second gear 3031 engaging with the transmission member 302 and a clamping shaft 3033. An inserting hole 3035 is defined in a central portion of the second gear 3031. The clamping shaft 3033 includes a cylindrical inserting portion 3037 corresponding to the inserting hole 3035 and a cylindrical clamping portion 3039 having a rough surface coaxially connected to the inserting portion 3037. The inserting portion 3037 is inserted into the inserting hole 3035 and a mounting hole 1035, in the order written. Thus, the gear 3031 is rotatably mounted on the mounting board 103.

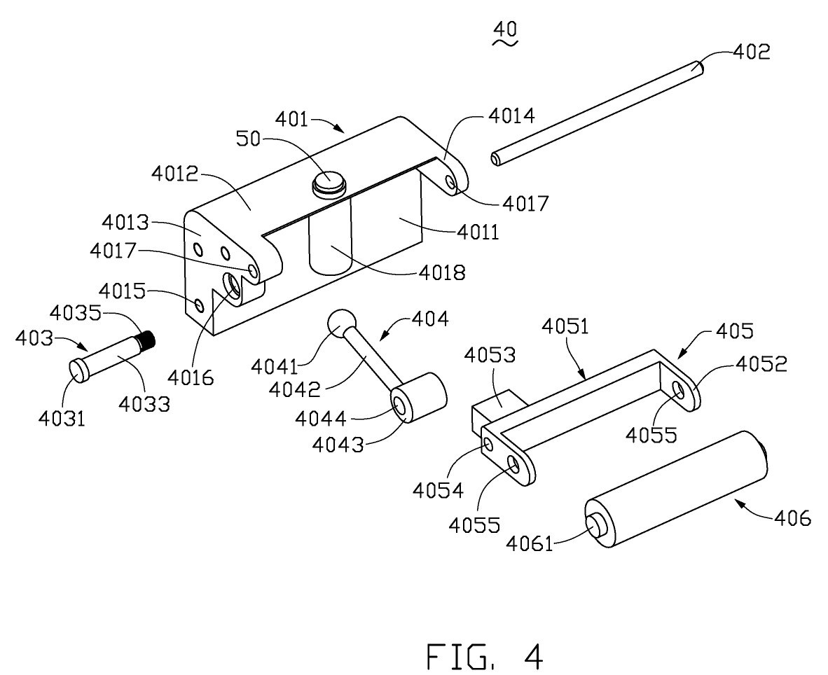

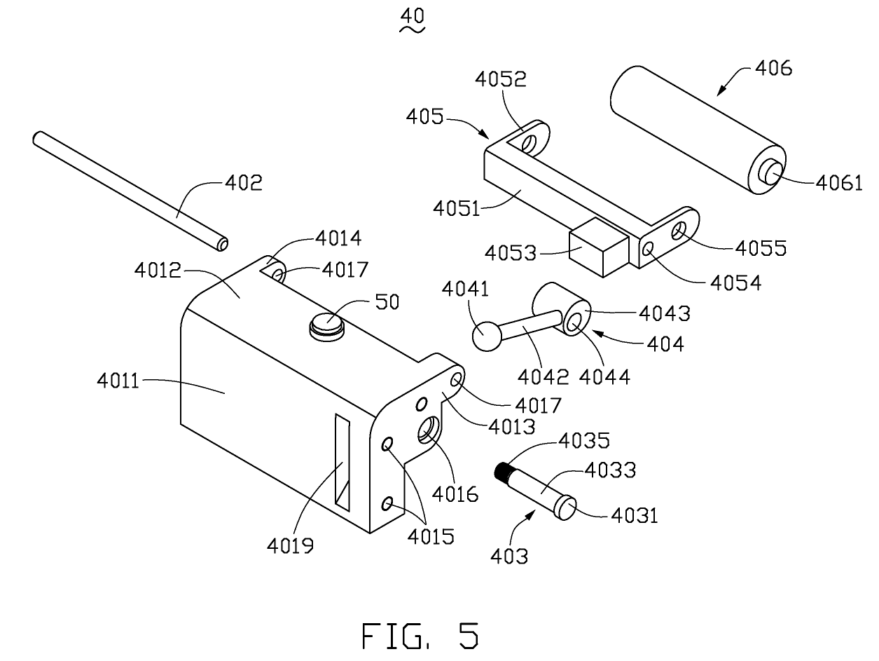

Also referring to FIG. 4 and FIG. 5, the clutch 40 includes a base 401, an axle 402, a bolt 403, an operating member 404, a frame 405 and a clamping wheel 406. The base 401 is a board bent to be approximately L-shaped, and includes a side portion 4011 and a top portion 4012 approximately perpendicularly connected to the side portion 4011. A first assembling wall 4013 and a second assembling wall 4014 which are both perpendicular to the side portion 4011 and the top portion 4012 are respectively formed on two joints of the side portion 4011 and the top portion 4012. The first assembling wall 4013 defines a plurality of assembling holes 4015 for mounting the base 401 to the mounting board 103 and a thread hole 4016 corresponding to the bolt 403 therein. Two first axle holes 4017 corresponding to the axle 402 are respectively defined in the first assembling wall 4013 and the second assembling wall 4014. A hollow cylindrical receiving portion 4018 for mounting the photoelectric switch 50 therein is formed in a middle portion of the top portion 4012. The base 401 also defines an operating groove 4019 for receiving the operating member 404.

The bolt 403 includes a head 4031, a thread portion 4035 and an axle portion 4033 connecting the head 4031 to the thread portion 4035. The operating member 404 includes an operating portion 4041, a cam 4043 and a connecting portion 4042 connecting the operating portion 4041 to the cam 4043. The cam 4043 defines a second axle hole 4044 corresponding to the axle portion 4033 therein. The frame 405 is approximately U-shaped, and includes a middle portion 4051 and two arm portions 4052 respectively formed on two ends of the middle portion 4051. A projecting resisting portion 4053 which is heavier than the total of other parts of the frame 405 and the clamping wheel 406 is formed on the middle portion 4051. The middle portion 4051 defines a third axle hole 4054 therein. Each arm portion 4052 defines a retaining hole 4055 to retain the clamping wheel 406. The clamping wheel 406 is a cylinder having a rough surface and has two retaining axles 4061 respectively formed on two ends thereof corresponding to the retaining holes 4055.

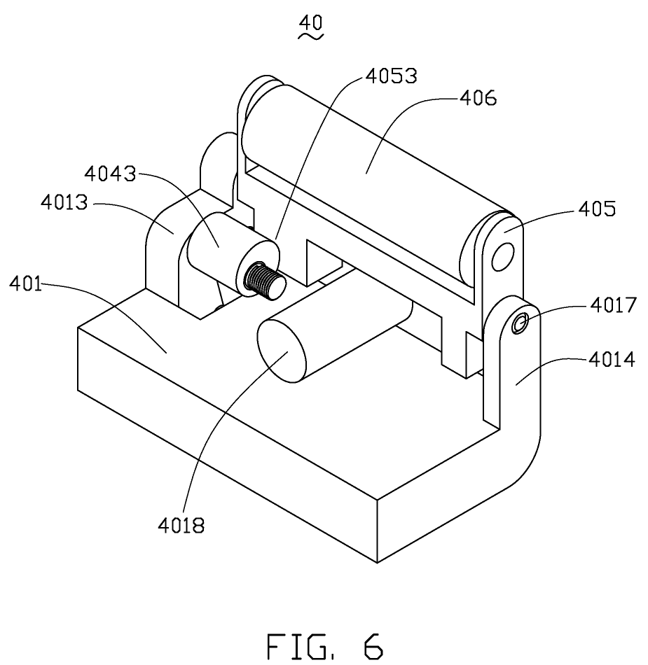

Also referring to FIG. 6, when the clutch 40 is assembled, the retaining axles 4061 are rotatably mounted in the retaining holes 4055, thus the clamping wheel 406 is rotatably mounted on the two arm portions 4052 of the frame 405. The axle 402 is inserted into a first axle hole 4017 of the base 401, in the order written. Thus, the two third axle holes 4054 of the frame 405 and another first hole 4017 of the base 401, thus the frame 405 is mounted on the base 401 via the axle 402. The operating portion 4041 and the connecting portion 4042 of the operating member 404 are both inserted into the operating groove 4019. The bolt 403 is screwed into the thread hole 4016 and inserted into the second axle hole 4044, thus the cam 4043 is mounted on the first assembling wall 4013 and adjacent to the resisting portion 4053 via the bolt 403. In this way, assembly of the clutch 40 is completed.

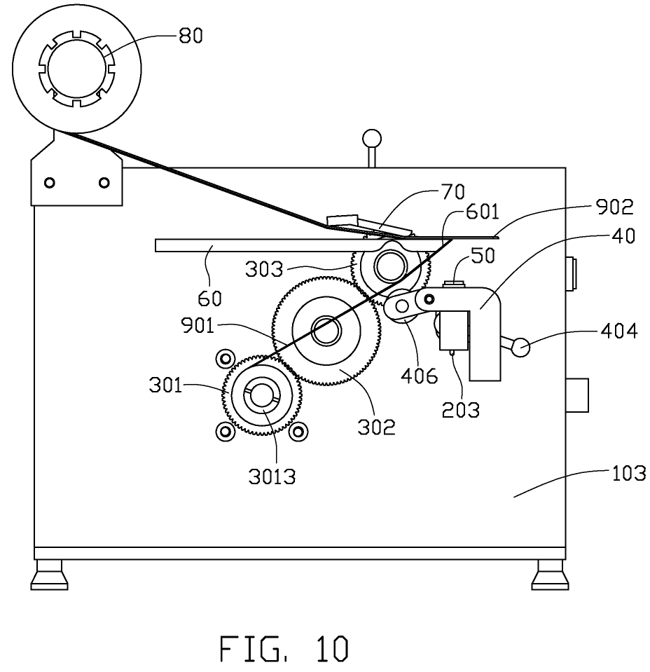

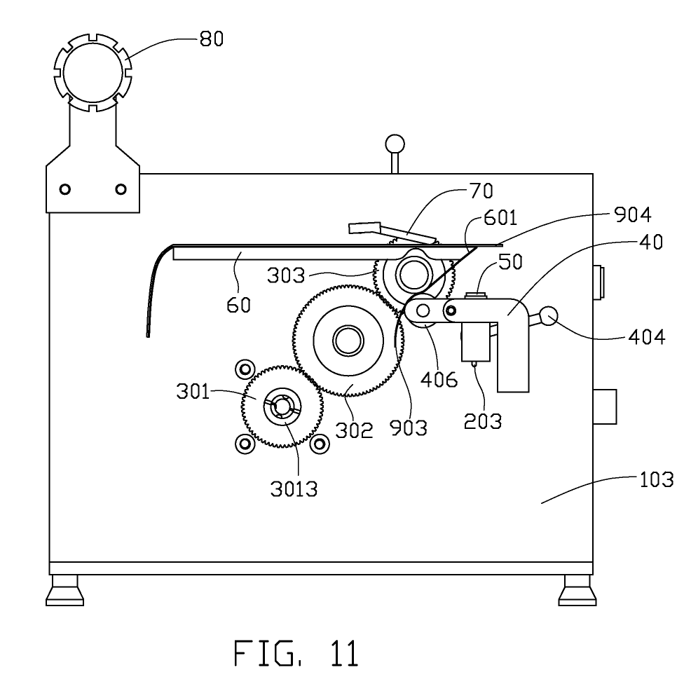

Also referring to FIG. 10, when the clutch 40 is operated, the operating portion 4044 is moved along the operating groove 4019. When the operating portion 4044 is moved away from the top portion 4012, the cam 4043 rotates around the axle portion 4033. Thus, the resisting portion 4053 is pushed away from the bolt 403 by the cam 4043, the frame 405 is driven to rotate, and the clamping wheel 406 is moved towards the base 401. This state of the clutch 40 is defined as an opening state. Also referring to FIG. 11, when the operating portion 4044 is moved towards the top portion 4012, the cam 4043 rotates around the axle portion 4033. Thus, the resisting portion 4053 moves towards the bolt 403 since it is heavier than the total of other parts of the frame 405 and the clamping wheel 406. In this way, the frame 405 is driven to rotate by the weight of the resisting portion 4053, and the clamping wheel 406 is moved away from the base 401. This state of the clutch 40 is defined as a close state.

The photoelectric switch 50 is mounted in the receiving portion 4018 and electronically connected to the power device 20 via a wire 203 for controlling the power device 20.

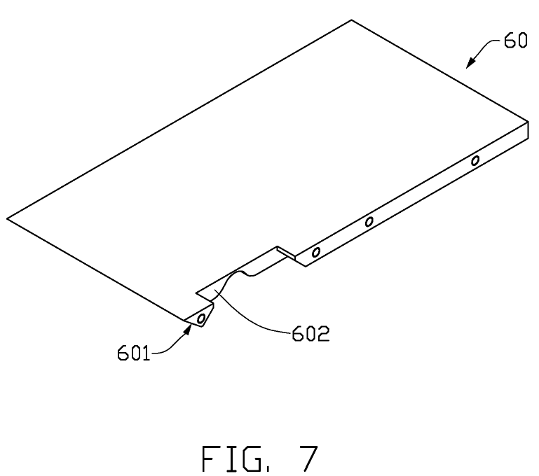

Also referring to FIG. 1 and FIG. 7, the peeling member 60 is an approximately rectangular board perpendicularly mounted on the outer mounting surface 1031 of the mounting board 103. A wedge portion 601 for bending tapes is formed on an end of the peeling member 60, and a gap 602 for receiving the second gear 3031 is defined in a side of the peeling member 60.

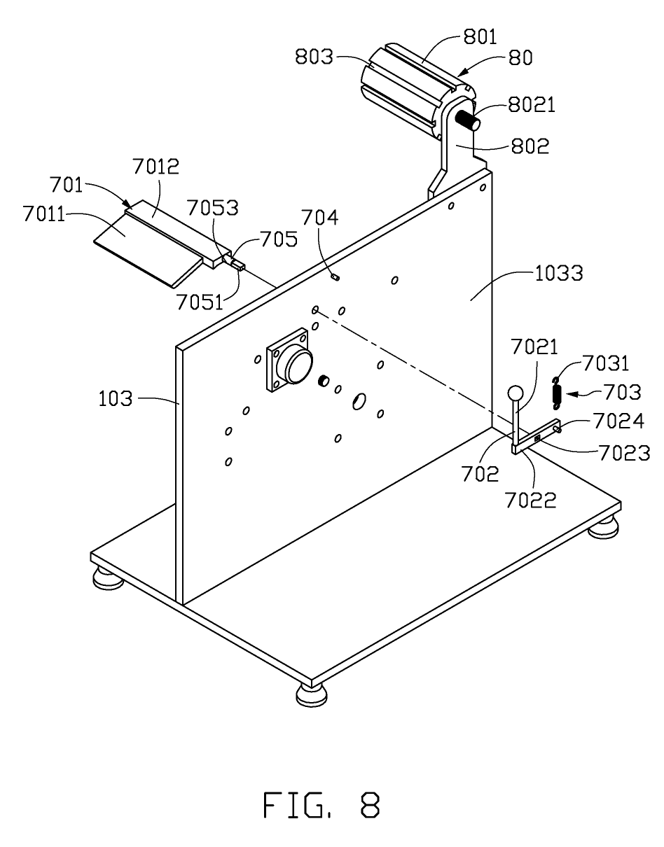

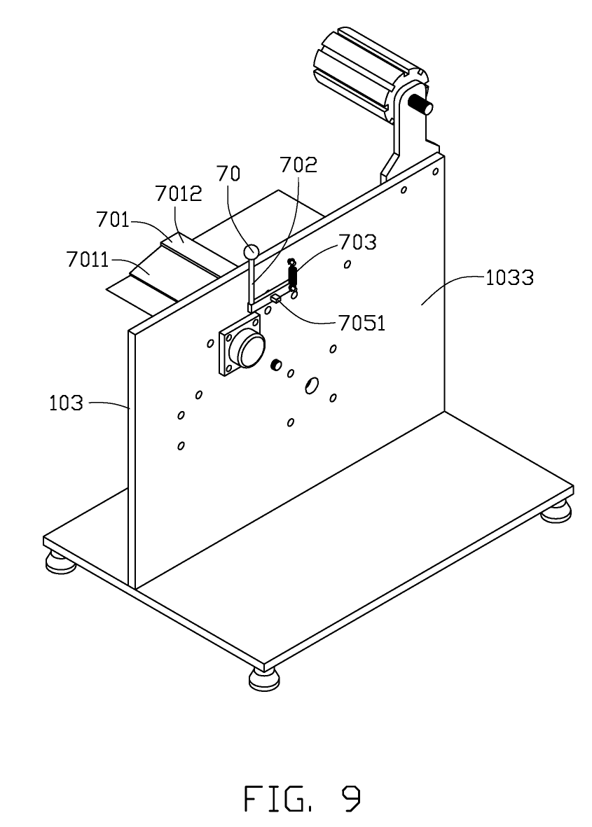

Also referring to FIG. 8 and FIG. 9, the pressing mechanism 70 includes a pressing board 701, a connecting rod 702, a resilient component 703, a cylindrical suspending component 704 and a holding axle 705. The pressing board 701 includes a pressing portion 7011 and a main portion 7012 connected to the pressing portion 7011. The connecting rod 702 is approximately L-shaped and includes an operating rod 7021 and a linkage rod 7022 perpendicularly connected to the operating rod 7021. The operating rod 7021 is mounted in the operating groove 1041 of the top board 104, and can be moved along the operating groove 1041. The linkage rod 7022 defines a connecting hole 7023 in its middle portion. A cylindrical hooking component 7024 is perpendicularly formed on an extending end of the linkage rod 7022.

The resilient component 703 is a cylindrical extension spring, each end of the resilient component has a hook 7031. The suspending component 704 is perpendicularly formed on the inner mounting surface 1033 of the mounting board 103. One hook 7031 hooks the suspending component 704, and another hook 7031 hooks the hooking component 7024. The holding axle 705 includes a holding portion 7051 and a rotatable portion 7053. The holding portion 7051 is a prism corresponding to the connecting hole 7023. The rotatable portion 7053 is a cylinder corresponding to the mounting hole 1035 and connects the holding portion 7051 to the main portion 7012. The holding axle 705 is inserted into a mounting hole 1035, the rotatable portion 7053 is rotatably mounted in the mounting hole 7035, and the holding portion 67051 is then inserted into the connecting hole 7023 to connect the connecting rod 702 with the pressing board 701.

Also referring to FIG. 8, the rotating mechanism 80 includes a rotating barrel 801 for mounting coiled tapes thereon and a housing 802 for mounting the rotating barrel 801. The rotating barrel 801 defines a plurality of skidproof apertures 803 parallel to its axle and opening on its side face. The housing 802 is mounted on the outer mounting surface 1031 of the mounting board 103 and includes a mounting axle 8021. The rotating barrel 8021 is rotatably mounted on the housing 802 via the mounting axle 8021.

Also referring to FIG. 2, in assembly, the power device 20 is mounted on the inner mounting surface 1033 via the pedestal 201. Also referring to FIG. 1 and FIG. 3, the first rotating member 301, the transmission member 302 and the second rotating member 303 are all mounted on the outer mounting surface 1031. The first rotating member 301 is mechanically connected to the power device 20, thus the power device 20 can drive the first rotating member 301 to rotate. The clutch 40 is mounted on the outer mounting surface 1031, and the clamping wheel 406 is positioned adjacent to the clamping portion 3039 of the second rotating member 303. The peeling member 60 is mounted on the outer mounting surface 1031 and positioned above the transmission member 302 and the clutch 40, the second rotating member 301 is partly received in the gap 602. The pressing mechanism 70 is mounted the on the outer mounting surface 1031 and positioned above the peeling member 60. The photoelectric switch 50 is mounted in the receiving portion 4018 and electronically connected to the power device 20, thus the power device 20 can be turned on or turned off by the photoelectric switch 50. The rotating mechanism 80 is mounted on the outer mounting surface 1031. Finally, the case 10 is assembled, and assembly of the label peeling apparatus 100 is completed.

The label peeling apparatus 100 can be used to peel labels attached on coiled tapes or flat tapes. Also referring to FIG. 10, the label peeling apparatus 100 is used to peel labels 902 detachably attached on a coiled tape 901 by glue. The tape 901 attached by the labels 902 is coiled on the rotating barrel 801. The tape 901 extends between the peeling member 60 and the pressing mechanism 70, then extends along the peeling member 60, and retraces at the end of the peeling member 60 forming the wedge portion 601 to surround the wedge portion 601. A part of the tape 901 is pressed by pressing board 701 of the pressing mechanism 70 to be tightened. The operating member 404 is moved a distance away from the top portion 4012 and fixed at an end of the operating groove 4019, thus the clutch 40 is adjusted to the aforementioned open state, i.e., the clamping wheel 406 is kept away from the clamping portion 3039. The retraced tape 901 extends between the clamping wheel 406 and the clamping portion 3039, and fixed on the tape recycling member 3013. The power device 20 is then turned on to drive the first rotating member 301 to rotate. The first rotating member 301 drives the tape 901 to move.

When the tape 901 attached by the labels 902 is driven to move around the wedge portion 601, the tape 901 is fully bent while the attaching labels 902 are prone to retain their original shapes. In this way, the labels 902 are peeled off the tape 901 and flatly extend from the end the peeling member 60 that forms the wedge portion 601. When the labels 902 extend above and cover the photoelectric switch 50 mounted in the receiving portion 4018, the power device 20 is turned off. Thus, the labels 902 detached from the tape 901 can be removed and glued to workpieces. After the labels 902 above the photoelectric switch 50 is removed, the power device 20 is turned on, and the labels 902 attached on the tape 901 are peeled by means of the aforementioned method again. At the same time, the tape 901 without labels 902 is coiled around the tape recycling member 3013 to be recycled.

Also referring to FIG. 11, the label peeling apparatus 100 is used to peel labels 904 attached on a flat tape 903 via gluing. The tape 903 is flatly placed on the peeling member, and extends between the peeling member 60 and the pressing mechanism 70, then successively extends along the peeling member 60, and retraces at the end of the peeling member 60 forming the wedge portion 601 to surround the wedge portion 601. A part of the tape 903 is pressed to be tightened by pressing board 701 of the pressing mechanism 70. The operating member 404 is moved away from the top portion 4012 to adjust the clutch 40 to the aforementioned open state, i.e., the clamping wheel 406 is kept away from the clamping portion 3039. The retraced tape 903 extends between the clamping wheel 406 and the clamping portion 3039, and the operating member 404 is moved towards the top portion 4012 to adjust the clutch 40 to the aforementioned close state, thus the tape 903 is clamped between the clamping wheel 406 and the clamping portion 3039. The power device 20 is then turned on to drive the first rotating member 301, the transmission member 302 and the second rotating member 303 to rotate. In this way, the tape 903 is driven to move by the clamping portion 3039.

When the tape 903 attached by the labels 904 is driven to move around the wedge portion 601, the tape 903 is fully bent while the attaching labels 904 are prone to retain their original shapes. In this way, the labels 904 are peeled off the tape 903 and flatly extend above the wedge portion 601. When the labels 904 extend above the photoelectric switch 50 mounted in the receiving portion 4018 and cover the photoelectric switch 50, the power device 20 is automatically turned off. Thus, the labels 904 detached from the tape 903 can be removed and glued to workpieces. After the labels 904 above the photoelectric switch 50 is removed, the power device 20 is automatically turned on, and the labels 904 attached on the tape 903 are then peeled by means of the aforementioned method. At the same time, the tape 903 without labels 904 falls onto the outer bottom 1023 to be recycled.

Understandably, the transmission member 302 can be replaced by other gearings, such as a transmission belt. The transmission member 302 can be further omitted, thus the first rotating member 301 and the second rotating member 303 directly mesh with each other. The photoelectric switch 50 can be mounted on other positions where can be shielded by detached labels 902/904. The speed adjusting switch 106 can be used to adjust moving speed of the tapes 901/903.

The label peeling apparatus 100 can quickly peel a great number of labels from tapes, and can automatically stop so that operators have adequate time to remove peeled labels. Thus, working efficiency is increased while workload of the operators is decreased.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A label peeling apparatus, comprising:
a case;
a power device mounted on the case;
a tape driving mechanism mounted on the case and driven by the power device, the tape driving mechanism driving a tape to move, wherein the tape is attached with labels; and
a peeling member mounted on the case configured for peeling the labels from the tape.

2. The label peeling apparatus as claimed in claim 1, wherein the tape driving mechanism includes a first rotating member mounted on the case and driven by the power device.

3. The label peeling apparatus as claimed in claim 2, wherein the tape driving mechanism includes a second rotating member mounted on the case and driven by the first rotating member, and the second rotating member includes a clamping portion.

4. The label peeling apparatus as claimed in claim 3, further comprising a transmission member, the transmission member being a gear, the first rotating member including a first gear, the second rotating member including a second gear, the transmission meshing with the first gear and the second gear.

5. The label peeling apparatus as claimed in claim 3, further comprising a clutch mounted on the case and including a clamping wheel, the clamping wheel being positioned adjacent to the clamping portion, the clamping portion cooperating with the clamping wheel to clamp the tape, and a distance between the clamping wheel and the clamping portion being adjustable.

6. The label peeling apparatus as claimed in claim 5, wherein the clutch includes a base, an operating member and a frame, the clamping wheel being mounted on the frame, the operating member being mounted on the base and including an cam to adjust position of the frame, and the frame being rotatably mounted on the base.

7. The label peeling apparatus as claimed in claim 2, wherein the tape driving mechanism includes a second rotating member driven by the first rotating member and including a clamping portion, the label peeling apparatus including a clutch, the clutch including a clamping wheel, the clamping portion cooperating with the clamping wheel to clamp the tape, and a distance between the clamping wheel and the clamping portion being adjustable.

8. The label peeling apparatus as claimed in claim 1, further comprising a clamping portion and a clutch, the clutch including a clamping wheel, the clamping portion cooperating with the clamping wheel to clamp the tape, and a distance between the clamping wheel and the clamping portion being adjustable.

9. The label peeling apparatus as claimed in claim 1, further comprising a rotating mechanism configured to coil the tape thereon.

10. The label peeling apparatus as claimed in claim 1, wherein the pressing mechanism is mounted above the peeling member to press and tighten the tape.

11. The label peeling mechanism as claimed in claim 1, wherein the pressing mechanism includes a pressing board, a connecting rod rotatably mounted on the case and connected to the pressing board, and a resilient member; one end of the resilient member being connected to the connecting rod and another end of the resilient member being connected to the case.

12. The label peeling apparatus as claimed in claim 1, further comprising a photoelectric switch configured for sensing peeled labels and control the power device.
